(19) United States
(12) Patent Application Publication
(10) Pub. No.: US 2025/0189446 A1
(43) Pub. Date: Jun. 12, 2025

(54) SYSTEM AND METHOD FOR PERFORMING CHARACTERIZATION OF A SAMPLE USING MULTI-WAVELENGTH LASER ACOUSTICS

(71) Applicant: Onto Innovation Inc., Wilmington, MA (US)

(72) Inventors: Manjusha Mehendale, Morristown, NJ (US); George Andrew Antonelli, Flanders, NJ (US)

(73) Assignee: Onto Innovation Inc., Wilmington, MA (US)

(21) Appl. No.: 18/851,340

(22) PCT Filed: Mar. 31, 2022
(86) PCT No.: PCT/US2022/022941

§ 371 Date: Sep. 26, 2024

(51) Int. Cl. G01N 21/63; G01N 21/31; G01N 29/04; G01N 29/24

(52) U.S. Cl. CPC G01N 21/63; G01N 21/31; G01N 29/04; G01N 29/2418

(57) ABSTRACT

An opto-acoustic metrology device, such as a picosecond laser acoustic metrology device, includes a laser light source that generates pulsed light with a first wavelength and a supercontinuum generator spectrally broadens the pulsed light. A pump arm receives the pulsed light and generates pump pulses to irradiate a target sample to cause transient perturbation in the target sample. A probe arm receives the pulse light and generates probe pulses to irradiate the target sample to produce reflected probe pulses that are modulated based on the transient perturbation in the target sample. The pump pulses and the probe pulses have different wavelengths or the same wavelengths that are selected from the spectrally broadened pulsed light, e.g., using a filter located before the pump and probe arms or within one of the pump or probe arms. A property of the target sample may be determined based on reflected probe pulses.

### FIELD OF THE DISCLOSURE

Embodiments of the subject matter described herein are related generally to non-destructive measurement of a sample, and more particularly to characterization of a sample using optical metrology.

### BACKGROUND

Semiconductor and other similar industries often use optical metrology equipment to provide non-contact evaluation of substrates during processing. With optical metrology, a sample under test is illuminated with light, e.g., at a single wavelength or multiple wavelengths. After interacting with the sample, the resulting light is detected and analyzed to determine a desired characteristic of the sample.

There are many different techniques for measuring characteristics of samples such as, for example, semiconductors. One such technique is opto-acoustic metrology, in which an acoustic wave generated with a pump beam reflects a portion of a probe beam that interferes with another portion of the probe beam reflected from a surface interface. The interference measurements produced using opto-acoustic metrology may provide information about characteristics of the sample. Picosecond acoustics (ultrasonics), for example, uses a short light pulse as a pump that when absorbed by a sample launches a strain pulse into the sample. The strain pulse may be partially reflected at each interface in the sample producing reflected pulses that propagate back towards the sample surface. The returning strain pulses may change the optical reflectivity of the structure, which may be measured using a time-delayed probe pulse.

### SUMMARY

An opto-acoustic metrology device, such as a picosecond laser acoustic metrology device, includes a laser light source that generates pulsed light with a first wavelength and a supercontinuum generator spectrally broadens the pulsed light. The laser light source may generate a single pulsed light beam (for a homodyne configuration) or two pulsed light beams (for a heterodyne configuration). A pump arm receives the pulsed light and generates pump pulses to irradiate a target sample to cause transient perturbation in the target sample. A probe arm receives the pulse light and generates probe pulses to irradiate the target sample to produce reflected probe pulses that are modulated based on the transient perturbation in the target sample. The supercontinuum generator may spectrally broaden the pulsed light in the optical path before the pump arm and probe arm, or within one of the pump arm or probe arm. One or more wavelengths may be selected from the spectrally broadened pulsed light so that the pump pulses and the probe pulses may have different wavelengths or the same wavelengths. A property of the target sample may be determined based on reflected probe pulses.

In one implementation, an opto-acoustic metrology device for non-destructive metrology of a target sample, includes a laser light source for generating pulsed light having a first wavelength, and a supercontinuum generator that receives the pulsed light having the first wavelength and spectrally broadens the pulsed light. A pump arm in the opto-acoustic metrology device is configured to receive the pulsed light and to irradiate the target sample with one or more pump pulses to cause transient perturbation in material in the target sample. A probe arm in the opto-acoustic metrology device is configured to receive the pulsed light and to irradiate the target sample with one or more probe pulses to produce reflected probe pulses that are modulated based on the transient perturbation in the material. The one or more pump pulses and the one or more probe pulses have different wavelengths or same wavelengths selected from the spectrally broadened pulsed light. The opto-acoustic metrology device may further include one or more detectors for receiving reflected probe pulses from the target sample, and at least one processor coupled to the one or more detectors and configured to determine the at least one property of the target sample based on reflected probe pulses.

In one implementation, a method for non-destructive opto-acoustic metrology of a target sample using an opto-acoustic metrology device may include generating pulsed light having a first wavelength with a laser light source, and spectrally broadening the pulsed light with a supercontinuum generator. One or more pump pulses are generated using the pulsed light in a pump arm that cause transient perturbation in material in the target sample that the one or more pump pulses irradiate. One or more probe pulses are generated using the pulsed light in a probe arm that produce from the target sample that the one or more probe pulses irradiate reflected probe pulses that are modulated based on the transient perturbation in the material. The one or more pump pulses and the one or more probe pulses have different wavelengths or same wavelengths selected from the spectrally broadened pulsed light. The method may further include detecting with one or more detectors reflected probe pulses from the target sample, and determining at least one property of the target sample based on reflected probe pulses.

In one implementation, an opto-acoustic metrology device for non-destructive metrology of a target sample, may include a laser light source for generating pulsed light having a first wavelength. The opto-acoustic metrology device includes a means for spectrally broadening the pulsed light. A pump arm in the opto-acoustic metrology device is configured to receive the pulsed light and to irradiate the target sample with one or more pump pulses to cause transient perturbation in material in the target sample. A probe arm in the opto-acoustic metrology device is configured to receive the pulsed light and to irradiate the target sample with one or more probe pulses to produce reflected probe pulses that are modulated based on the transient perturbation in the material. The one or more pump pulses and the one or more probe pulses have different wavelengths or same wavelengths selected from the spectrally broadened pulsed light. The opto-acoustic metrology device may further include one or more detectors for receiving reflected probe pulses from the target sample, and at least one processor coupled to the one or more detectors and configured to determine the at least one property of the target sample based on reflected probe pulses.

### BRIEF DESCRIPTION OF THE DRAWINGS

FIG. 1A illustrates a schematic representation of an opto-acoustic metrology device that includes a supercontinuum generator to alter the wavelengths of one or more of pump and probe pulses.

FIG. 1B illustrates a graph showing a change in reflectance with respect to time delay in an opto-acoustic measurement.

FIG. 2 illustrates a schematic representation of an implementation of the opto-acoustic metrology device with a wavelength selector before the pump arm and probe arm and the pump pulses and probe pulses having different wavelengths.

FIG. 3 illustrates a schematic representation of another implementation of the opto-acoustic metrology device with a wavelength selector before the pump arm and probe arm and the pump pulses and probe pulses having different wavelengths.

FIG. 4 illustrates a schematic representation of an implementation of the opto-acoustic metrology device with a wavelength selector in one of the pump arm or probe arm and the pump pulses and probe pulses having different wavelengths.

FIG. 5 illustrates a schematic representation of an implementation of the opto-acoustic metrology device with a heterodyne configuration with a wavelength selector in one of the pump arm or probe arm and the pump pulses and probe pulses having different wavelengths.

FIG. 6 illustrates a schematic representation of another implementation of the opto-acoustic metrology device with a heterodyne configuration with a wavelength selector in one of the pump arm or probe arm and the pump pulses and probe pulses having different wavelengths.

FIGS. 7-10 illustrate a schematic representation of another implementation of the opto-acoustic metrology device with a wavelength selector before the pump arm and probe arm and that selects the pump pulses and probe pulses to have different wavelengths or the same wavelength.

FIG. 11 illustrates a schematic representation of an implementation of the opto-acoustic metrology device with a wavelength selector and a pulse shaper in the pump arm.

FIG. 12 is a flow chart illustrating a method non-destructive opto-acoustic metrology of a target sample using an opto-acoustic metrology device as described herein.

### DETAILED DESCRIPTION

During fabrication of semiconductor and similar devices it is sometimes necessary to monitor the fabrication process by non-destructively measuring the devices. Optical metrology is sometimes employed for non-contact evaluation of samples during processing. For example, opto-acoustic metrology, such as picosecond acoustics (ultrasonics), may be used to evaluate samples, such identify the presence and location of non-uniformities or the thickness of various films structures within a sample.

During fabrication, a sample may have different surface layers at different points in the fabrication. Moreover, different samples may have different types of layers. Different materials in these layers may behave differently for different wavelengths of light, e.g., different materials may be transparent or opaque at different wavelengths of light. Opto-acoustic metrology, such as picosecond ultrasonics, however, rely on the use of light pulses generated by lasers, and are therefore limited to the specific wavelength of the laser, which may be limiting with respect to the different types of materials with which it may be used.

Picosecond ultrasonics, for example, is well-established for metrology of thin metal films and uses a femtosecond laser pulse generates an acoustic wave which suffers partial reflection at the interface between metal and substrate. Another short laser pulse derived from the same laser is then used to detect the change in reflectivity due to the arrival of the acoustic wave. The efficiency of the signal depends on the absorption of the pump beam to generate strong acoustic waves and the piezoreflectance of the sample for strong probe beam reflection. The absorption and piezoreflectance of different metals vary as a function of the laser wavelength. Ideally an ultrafast laser with varying wavelength is required for optimal performance for different applications. There have been efforts to address this with the inclusion of laser sources including second harmonic generator which restrict the wavelength choice to only two different fixed wavelengths or using OPAs (Optical Parametric Amplifiers) which can generate short laser pulses with varying wavelengths, but these are prohibitively expensive.

Accordingly, as described herein, an optical metrology device performs opto-acoustic metrology on a sample using a laser light source that generates pulsed light with a first a wavelength and a supercontinuum generator that receives the pulsed light and spectrally broadens the pulsed light. Several different concepts can be manifested customizing the optical configuration. This technique may not be restricted to the standard pump-probe measurement setup using mechanical delay line for variable time delay but can also be a part of the setup employing asynchronous optical sampling (ASOPS) for picosecond acoustic measurements.

For example, in one implementation, the supercontinuum generator may spectrally broaden the pulsed light from the main laser source, e.g., in the visible and near infrared (NIR) using either the fundamental or the second harmonic of the laser. In some implementations, the spectrum may be divided into two parts with the help of a dichroic filter and each spectral component may be used for pump and probe beams respectively thus enabling the dual wavelength picosecond ultrasonics measurements. In another implementation, a band pass or acousto-optic filter for wavelength selection before splitting the beam into pump and probe beams.

In another implementation, the supercontinuum generator may spectrally broaden the pulsed light in the probe beam path (or pump beam path). For example, a band pass or acousto-optic filter may be used to select different wavelengths depending on the sample under consideration. In this example, the pump wavelength (or probe beam path) will be same as the wavelength of the master laser source (IR or visible). By enabling the ability to vary the probe wavelength from visible to near infrared spectral range with the help of a filter such as an acousto-optic filter, the signal may be optimized depending on the piezoreflectance of the sample.

In another implementation, the supercontinuum generator may spectrally broaden the pulsed light with zero dispersion at two different wavelengths closely spaced (e.g. 775 nm and 945 nm). In this case, if the pumping wavelength happens to be in between the two wavelengths (e.g. 800 nm), the generated spectrally broadened light will have all the powers distributed between two bands instead of as a continuum. The two spectral bands may be at above the higher zero dispersion wavelength (e.g., >945 nm) and below the lower zero dispersion wavelength (e.g., <775 nm), which may be attributed to four wave mixing and self phase modulation in the supercontinuum generator. This implementation may be used advantageously by assigning each spectral band to pump and probe beams respectively. Using a combination of optical elements, such as dichroic mirrors and filter wheels (that include special coatings acting as dichroic mirrors or beam splitters or high reflective mirrors), the opto-acoustic metrology device may be configured to include various combinations of pump and probe beam wavelengths. Moreover, due to non-linearities in the supercontinuum generator and the fact that it produces zero dispersion at two different wavelengths in two separate spectral bands, the amount of energy provided to each spectral band is determined by the original wavelength of the pumping wavelength and, accordingly, by adjusting the pumping wavelength provided to the supercontinuum generator, the ratio of the powers in the two spectral bands may be adjusted, and the opto-acoustic metrology device may be configured to have both pump and probe beams in the IR or in the visible.

In another implementation, regardless of whether the supercontinuum generator spectrally broadens the pulsed light before the pump and probe beams are separated or within the probe (or pump) arm, the pump beam may pass through a pulse shaper, such as spatial light modulator or acousto-optic modulator. The pulse shaper may be employed to vary the pulse characteristics by modifying the intensity and phase of the pump pulse. By varying the pulse characteristics enhancement or suppression of certain acoustic phonon modes may be achieved in some samples. Moreover, an adaptive algorithm can be used to define the optimum pulse shape that yields a desirable control over the phonon dynamics in the sample under consideration.

The opto-acoustic metrology device may have a homodyne configuration, e.g., with a single laser that generates the pulsed light that is split between the pump and probe arms with a variable delay stage used to generate the delay between the pump and probe pulses. In another example, the optical metrology configuration may have a heterodyne configuration, in which the light source generates separate pump and probe beams with the delay between the pump and probe produced based on slightly different frequencies of the pulses in the pump and probe beams.

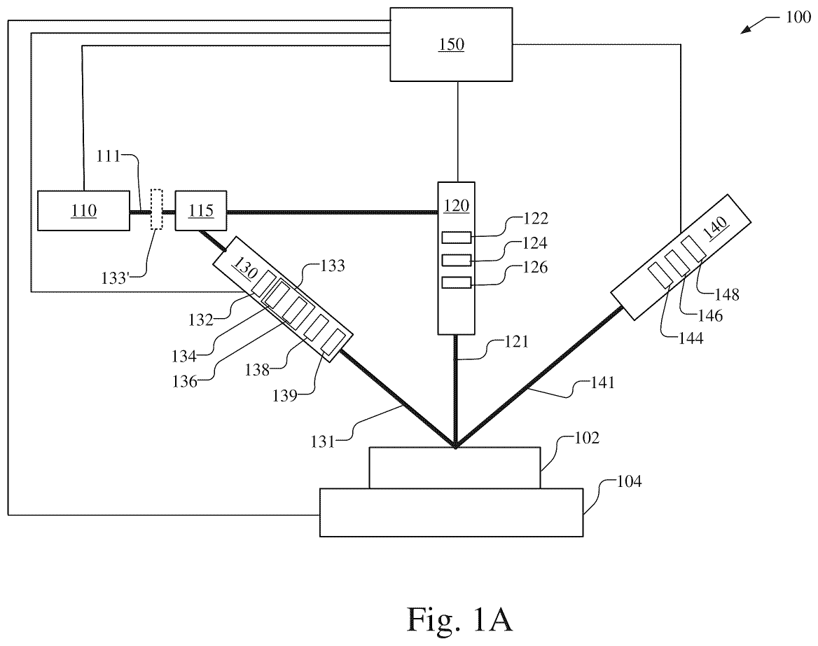

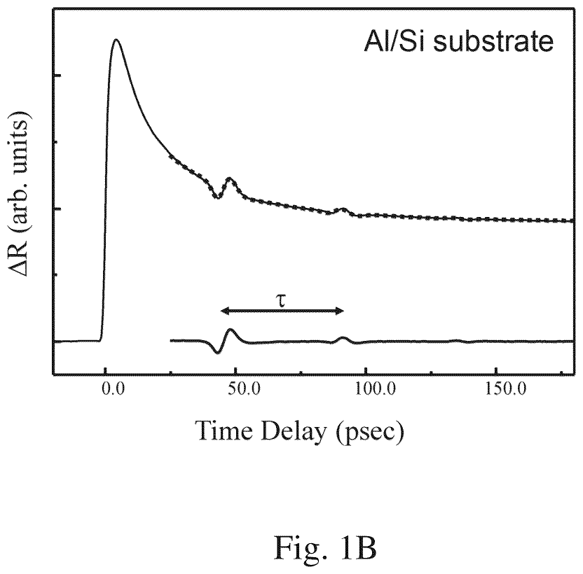

FIG. 1A illustrates a schematic representation of an opto-acoustic metrology device 100 that may employ a supercontinuum generator to alter the wavelengths of one or more of the pump and probe pulses as discussed herein. The opto-acoustic metrology device 100 may be further configured to employ a pulse shaper for pulses in the pump beam. It should be understood that FIG. 1A illustrates a simplified view of the opto-acoustic metrology device 100 and that additional optical components, e.g., lenses, polarizers, waveplates, etc. may be included.

The opto-acoustic metrology device 100 includes a pulsed light source 110 that produces pulsed light 111. The pulsed light source 110, for example, may be a single wavelength laser or a narrowband laser. The pulsed light source 110 may be a single pulsed laser that produces the pulsed light 111, which may have a pulse width in the range of several hundred femtoseconds to several hundred picoseconds. In some implementations, the pulsed light 111 may be a single beam that is split between a pump arm 120 and a probe arm 130. In some implementations, the pulsed light 111 may be two separate pulsed beams that are directed to the pump arm 120 and probe arm 130, respectively. For example, the pulsed light source 110 may be two separate pulsed lasers that generate separate pulsed beams as the pulsed light 111 with slightly different frequency combs. The two separate pulsed lasers may be synchronized to produce small difference in repetition rates. In another example, the pulsed light source 110 may be a single pulsed laser that generates separated pulsed beams as the pulsed light 111 with slightly different frequency combs.

As illustrated, the opto-acoustic metrology device 100 may include an optical system 115 that directs the pulsed light 111 to a pump arm 120 and a probe arm 130. The optical system 115, for example, may be a beam splitter that distributes the pulsed light 111 towards the pump arm 120 and the probe arm 130. In another example, the optical system 115 may include one or more filters, mirrors, dichroic mirrors, beam dumps, etc., to distributes the pulsed light 111 towards the pump arm 120 and the probe arm 130. In some implementations, the supercontinuum generator may be located before the optical system 115 (e.g., between the pulsed light source 110 and the optical system 115) and the optical system 115 may select the portions of the pulsed light 111 to distribute to the pump arm 120 and the probe arm 130 so that pump pulses and probe pulses incident on the sample may have different wavelengths or the same wavelengths. In some implementations, the supercontinuum generator may be located after the optical system 115 (e.g., in the probe arm 130) and the optical system 115 may distribute desired ratios of the pulsed light 111 to the pump arm 120 and the probe arm 130. In some implementations, the pulsed light source 110 generates two separate pulsed beams as the pulsed light and the optical system 115 may direct different pulsed beams to the pump arm 120 and the probe arm 130.

The pump arm 120 receives at least a portion of the pulsed light 111 and directs a pulsed pump beam 121 to the target sample 102. As illustrated in FIG. 1A, the pump beam 121 may be directed (e.g., focused) by one or more lenses (not shown) to be normally incident on the target sample 102, but non-normal angles of incidence may be used if desired, e.g., including but not limited to between normal and 70° incidence angle. The pump beam 121 produced by the pump arm 120 irradiates the target sample 102 and causes a transient perturbation in the material of the target sample 102.

In some implementations the pump arm 120 may include a delay stage 122 for increasing or decreasing the length of the optical path between the pulsed light source 110 and the target sample 102 to control the delay of the pulses in the pump beam 121. The delay stage 122, for example, may vary the optical path length to control a time delay between irradiating the target sample 102 with each pulse in the pump beam 121 and irradiating the target sample 102 with a corresponding pulse in a probe beam 131.

The pump arm 120 may further include a pulse shaper 124 that receives the pulsed light 111 and varies at least one of a duration, phase, or both of the pulses in the pulsed light to produce the pump beam 121. The pulse shaper 124, for example, may be a spatial light modulator or an acousto-optic modulator. By way of example, all optical switching (AOS) of magnetic materials is a field of interest due to the demand to control magnetization in devices in a faster and more efficient manner. The study of the interaction of ultrafast lasers with ferromagnetic metals may lead to greater advances in future magnetic data storage devices. The pump beam 121 may be configured to induce magnetization dynamics, e.g., using femtosecond pump laser pulses. Opto-acoustic metrology device 100 may be used to study the optically induced magneto dynamics. Controlling the shape of the pulses of the pump beam 121 by varying the pulse duration and/or phase of the incident pump beam 121 using pulse shaper 124 may be used advantageously to determine the dependence of the magnetic dynamics in the target sample 102 on the pump pulse characteristics. Moreover, an adaptive algorithm may be used to define and use the optimum pulse shape of the pump beam 121 to yield desirable control over the magnetic dynamics in the target sample 102 under consideration.

The pump arm 120 may further include a modulator 126 to modulate the amplitude (intensity) of the pump beam 121. For example, the modulator 126 may modulate the amplitude (intensity) of the polarized probe pulses in the pump beam 121. The modulator 126 may be an electro-optic modulator (EOM), acousto-optic modulator (AOM), photoelastic modulator (PEM), or a chopper, which may modulate amplitude (intensity) of the pump beam 121, which is advantageous as it enables measurements at high sensitivity, low noise and at a fast speed.

Many other alternative configurations of the pump arm 120 are also possible. For example, the pump arm 120 may include only the delay stage 122, the modulator 126, or the pulse shaper 124, or may include any combination thereof. Further additional optical elements may be present in the pump arm 120. It should be appreciated that the illustration of pump arm 120 in FIG. 1A is not intended to be limiting, but rather depict one of a number of example configurations.

The probe arm 130 receives at least a portion of the pulsed light 111 and directs a probe beam 131, e.g., which may include one or more polarized pulses, to irradiate the target sample 102. The probe beam 131 may be directed (e.g., focused) by lenses (not shown) to be obliquely incident on the target sample 102, e.g., at any angle between 5 and 70 degrees from normal.

The probe arm 130, for example, may include one or more polarization elements 138 (e.g., polarizer(s) and/or waveplate(s)) that produce one or more polarization states and optional phase shifts, which may be configurable, e.g., rotatable, to produce a desired polarization state in the probe beam 131. In some implementations, the probe arm 130 may include a delay stage 132 for increasing or decreasing the length of the optical path between the pulsed light source 110 and the target sample 102 to control the delay of the pulses in the probe beam 131.

The probe arm 130 may further include a wavelength selector 133 that may receive the pulsed light 111 in the probe arm 130 and select one or more wavelengths to be used in the probe beam 131. The wavelength selector 133, for example, may include a multi-wavelength generator 134, which may receive a single wavelength or narrowband wavelengths in the pulsed light 111 and spectrally broadens the pulsed light 111. The multi-wavelength generator 134, for example, may be a supercontinuum generator that spectrally broadens light. In some implementations, the multi-wavelength generator 134 may be a multiple harmonic generator, such as a frequency doubling crystal (DBO), that receives a narrow band of wavelengths and produces wider band of wavelengths. In some implementations, the multi-wavelength generator 134 may be photonic crystal fibers that receive a narrow band of wavelengths and produces wider band of wavelengths. In some implementations, the multi-wavelength generator 134 spectrally broadens the pulsed light 111 to produce a continuous optical spectrum. In some implementations, the multi-wavelength generator 134 spectrally broadens the pulsed light 111 to produce multiple discontinuous optical spectral bands. The multi-wavelength generator 134 enables an ability to increase the wavelengths of the probe beam 131, e.g., from visible to near infrared spectral range, which may be continuous or discontinuous wavelengths, and which may be filtered to select a particular wavelength or narrowband of wavelengths for measurement of the target sample 102. For example, in some implementations, the wavelength selector 133 may further include a filter 136, such as an acousto-optic filter, a dichroic mirror, laser line filter, notch filters, etc., that when used with the multi-wavelength generator 134 enables an ability to select one or more specific wavelengths to be included in the probe beam 131, e.g., from visible to near infrared spectral range to be used for measuring a target sample 102. For example, some sample materials are opaque to certain wavelengths and transparent at other wavelengths. In some implementations, the filter 136 may be in one or more components of the optical system 115, such as a dichroic beam splitter. With the use of the multi-wavelength generator 134 and filter 136 in the wavelength selector 133, the wavelength(s) included in the probe beam 131 may be specifically selected by the opto-acoustic metrology device 100 based on the type of material of the target sample 102, which enables measurement of a wide range of different materials.

The probe arm 130, for example, may include one or more polarization elements 138 (e.g., polarizer(s) and/or waveplate(s)) that produce one or more polarization states and optional phase shifts, which may be configurable, e.g., rotatable, to produce a desired polarization state in the probe beam 131.

The probe arm 130 may further include a modulator 139 to modulate the amplitude and/or the phase of the probe beam 131. For example, the modulator 139 may modulate the amplitude (intensity) of the polarized probe pulses in the probe beam 131. The modulator 139 may periodically phase modulate polarized probe pulses in the probe beam 131. The modulator 139 may be an EOM, AOM, PEM, or rotating compensator, which may modulate phase of the probe beam 131 or an EOM, AOM, PEM, or chopper, which may modulate amplitude of the probe beam 131. The use of, e.g., an EOM may be advantageous as it enables measurements at high sensitivity, low noise and at a fast speed.

Many other alternative configurations of the probe arm 130 are also possible. For example, the probe arm 130 may include only the polarization elements 138, the delay stage 132, the wavelength selector 133 (including one or more of the multi-wavelength generator 134 and filter 136), the modulator 139, or may include any combination thereof. Further additional optical elements may be present in the probe arm 130. It should be appreciated that the illustration of probe arm 130 in FIG. 1A is not intended to be limiting, but rather depict one of a number of example configurations.

In some configurations, the probe arm 130 may not include a wavelength selector 133, as indicated with dotted lines, a wavelength selector 133′ may be located before optical system 115. The wavelength selector 133′ may be the same as wavelength selector 133 described above, e.g., including a one or more of the multi-wavelength generator 134 and filter 136. The wavelength selector 133′, for example, may generate multiple wavelengths, and the optical system 115 may select different wavelengths to direct to the pump arm 120 and the probe arm 130. In another implementation, the wavelength selector 133′, may select one or more specific wavelengths, and the optical system 115 directs the selected wavelength(s) to both the pump arm 120 and the probe arm 130.

The pump beam 121 and the probe beam 131 interact with target sample 102 and the probe beam 131 is reflected from the target sample 102 to a detector arm 140 as a reflected beam 141. The detector arm 140 includes one or more detectors, e.g., detectors 144 and/or 146, that receive the reflected probe pulses in the reflected beam 141 from the target sample 102. For surface deflection measurements, for example, both detectors 144 and 146 may be used and a difference measurement of the two signal detected by detectors 144 and 146 may be used. The one or more detectors 146 and/or 144 may be connected to a lock-in amplifier 148 that demodulate signals from the detectors 146 and/or 144 that are generated based on the received reflected probe pulses in the reflected beam 141 from the target sample 102.

Many other alternative configurations of the detector arm 140 are also possible. For example, the detector arm 140 may include detector 146, detector 144, lock-in amplifier 148 or any combination thereof. Further additional optical elements may be present in the detector arm 140. It should be appreciated that the illustration of detector arm 140 in FIG. 1A is not intended to be limiting, but rather depict one of a number of example configurations.

The pulsed light source 110, pump arm 120, probe arm 130, and detector arm 140 are connected to and controlled by a controller 150. Additionally, the controller 150 may be connected to and control a stage 104 that holds the target sample 102 and includes actuators to move the target sample 102 based on controls signals from the controller 150 to position the target sample 102 at desired measurement positions. The stage 104, for example, may be capable of horizontal motion in either Cartesian (i.e., X and Y) coordinates, or Polar (i.e., R and θ) coordinates or some combination of the two. The stage 104 may also be capable of vertical motion along the Z coordinate.

The controller 150 may further control the operation of a chuck on the stage 104 used to hold or release the target sample 102. It should be appreciated that the controller 150 may be a self-contained or distributed computing device capable of performing necessary computations, receiving, and sending instructions or commands and of receiving, storing, and sending information related to the metrology functions of the system.

The controller 150 includes one or more processors and may be a workstation, a personal computer, central processing unit or other adequate computer system, or multiple systems. It should be understood that controller 150 includes one processor, multiple separate processors or multiple linked processors that may be used together, all of which may interchangeably be referred to herein as controller 150, processor 150, at least one processor 150, one or more processors 150. The controller 150 is preferably included in, or is connected to, or otherwise associated with the opto-acoustic metrology device 100.

The controller 150 may also control the operation of the opto-acoustic metrology device 100 and collect and analyze the data obtained from the detector arm 140. The controller 150 may analyze the data to determine one or more physical characteristics of the target sample 102 based on the data obtained. For example, opto-acoustic metrology device 100 may be controlled by controller 150 to perform opto-acoustic measurements. The opto-acoustic measurements may be, e.g., picosecond ultrasonic measurements that may be used to measure depth resolved measurement of the non-uniformities in the target sample 102. The opto-acoustic measurements, for example, uses a pump beam 121 to produce a transient response in the target sample 102, e.g., a transducer layer, such as a metal layer, in the target sample 102 absorbs the pump pulse energy and launches a sound wave vertically into the target sample 102. The propagating sound wave interacts with the probe beam 131 via piezo-reflectance response, and is reflected. The light reflected from the propagating sound wave will interfere with the light reflecting from the top surface of the target sample 102 resulting in a characteristic oscillatory time-evolved signal, i.e., coherent Brillouin scattering. The period of oscillation reveals information regarding speed of sound and elastic modulus within the target sample 102. The depth-resolved oscillation period may be used to extract the speed of sound and Young's modulus at various depths in the target sample 102, which may be used to provide insight into the presence and location of non-uniformities or thickness measurements of opaque films.

The opto-acoustic metrology device 100 may perform opto-acoustic measurements using the pump arm 120 along with the probe arm 130. For example, the controller 150 may cause the pump arm 120, i.e., to produce a pump beam 121 that is incident on the target sample 102 and produces a transient response in the target sample 102. The pump beam 121 may be amplitude (intensity) modulated using modulator 126.

The probe arm 130 produces probe pulses in the probe beam 131. In some implementations, the probe beam may be amplitude (intensity) modulated by the modulator 139. The probe beam 131 interacts with the target sample 102 after each pump pulse. The opto-acoustic measurements may be collected as a function of the time delay between the pump beam 121 and the probe beam 131, e.g., controlled by the delay stage 122 in the pump arm 120 and/or the delay stage 132 in the probe arm 130 for a homodyne configuration, or controlled by the different frequency combs of separately generated pulsed light beams for a heterodyne configuration.

The characteristics of the materials, including types of material, thickness, and non-uniformities, in the target sample 102 will alter the propagation time of the sound wave within the target sample 102, and may be measured based on the reflected beam 141. The detector arm 140 may detect the changes in reflection or surface deformation in the reflected beam 141, e.g., using a detector 146 with respect to the time delay. FIG. 1B, by way of example, illustrates a graph showing a change in reflectance ΔR in arbitrary units with respect to time delay (psec) that may be measured by the opto-acoustic metrology device 100. By way of example, the thickness of the target sample 102 may be measured based on:

$$Thickness = \frac{τ * {v}_{s o u n d}}{2} \qquad eq . 1$$

where τ is the echo arrival time and v_{sound} is the speed of sound in the material of the target sample 102.

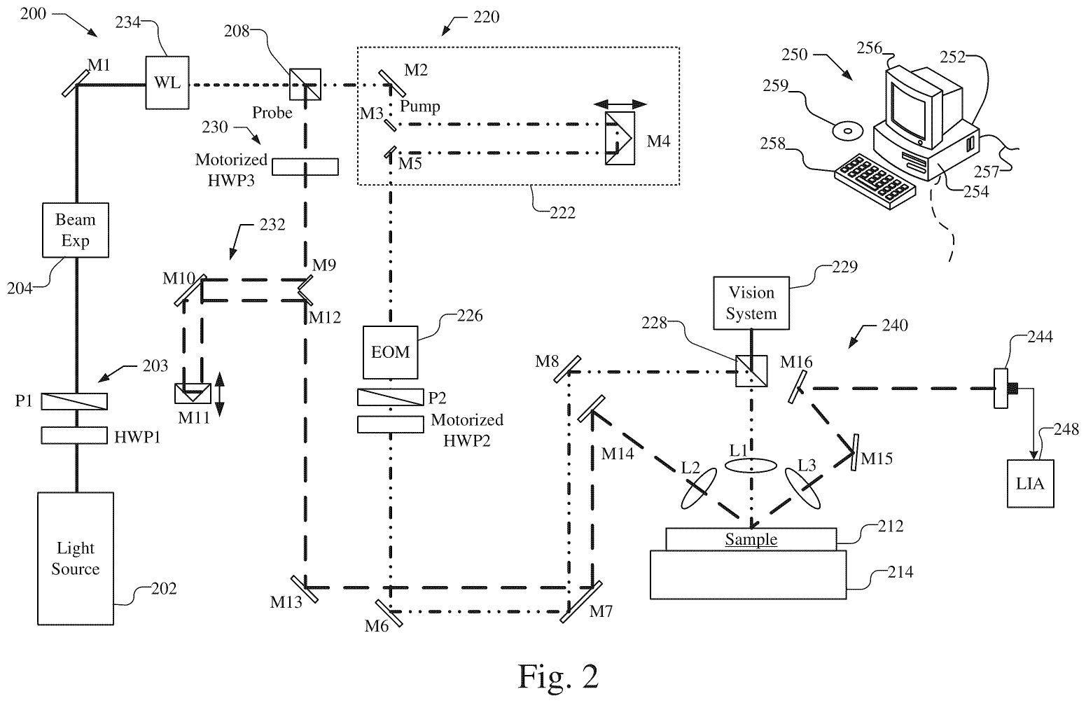

FIG. 2 illustrates a schematic representation of an opto-acoustic metrology device 200, which illustrates an implementation of the opto-acoustic metrology device 100 shown in FIG. 1A in which, as illustrated by the dotted and dashed lines, the pump and probe pulses incident on the sample 212 have different wavelengths. In FIG. 2, a wavelength selector is in the form of a multi-wavelength generator 234 that receives the pulsed light from a pulsed light source 202 and expands the spectrum of the pulsed light. A dichroic beam splitter 208 receives the pulsed light from the multi-wavelength generator 234 and directs different wavelengths to the pump arm 220 (which may be used as the pump arm 120 in FIG. 1A) and the probe arm 230 (which may be used as the probe arm 130 in FIG. 1A).

It should be understood that the opto-acoustic metrology device 200 may include components and subsystems in addition to those illustrated in FIG. 2, such as beam management and conditioning components, such as beam expanders, collimators, etc., as well as a beam power detector, and focus sensor, etc.

As illustrated, the light source 202, such as a 510-535 nm range, 50-400 fs, 20-150 MHz pulsed laser, produces a pulsed light beam. Other wavelengths, such as 800 nm or 1020-1070 nm, or other wavelengths may be used if desired. The light may be directed through an intensity control 203, including a half wave plate HWP1 and a polarizer P1. The light may pass through a beam expander 204, which may include a series of lenses that expands the beam. The light source 202, intensity control 203, and beam expander 204 may be used as the pulsed light source 110 illustrated in FIG. 1A.

The pulsed light from the light source 202 is directed to a beam splitter 208 by a mirror M1. Between the light source 202 and the beam splitter 208 is the wavelength selector in the form of a multi-wavelength generator 234. The multi-wavelength generator 234 receives the pulsed light 111, which is narrowband, and spectrally broadens the pulsed light. The multi-wavelength generator 234, for example, may be a supercontinuum generator, such as multiple harmonic generator, e.g., a DBO or photonic crystal fibers that receive a single or narrowband of wavelengths and produce multiple wavelengths in a continuous or dis-continuous spectrum wavelengths for the pulsed light. For example, a BBO or LBO crystal from Eksma and PCF from Thorlabs may be used. The multi-wavelength generator 234 enables an ability to alter the wavelengths used in the pump or probe beam, e.g., from visible to near infrared spectral range. The beam splitter 208 may be a dichroic beam splitter that is used to select the wavelength(s) of the pulsed light that is directed to the pump beam 220 and the wavelength(s) of the pulsed light that is directed to the probe beam 230. Thus, the multi-wavelength generator 234 and beam splitter 208 may be used as the wavelength selector 133′, including the multi-wavelength generator 134 and filter 136, as well as the optical system 115, shown in FIG. 1A.

The pump arm 220 includes a variable delay stage 222, which is illustrated as including a number of mirrors, M2, M3, M4, and M5, where the mirror M4 is movable, via a piezoelectric motor, to alter the length of the optical path to control the delay of the pulses in the pump beam produced by pump arm 220 to vary the time delay between pulses in the pump beam and the probe beam.

The pump beam passes through an EOM 226, such as a KD*P crystal based EOM, manufactured by Conoptics. The pump beam may further pass through a polarizer P2 and half wave plate HWP2 and is directed to the target sample 212 via mirrors M6, M7, M8, beam splitter 228 and lens L1. The lens L1 may include one or more reflective or refractive lenses or combination thereof. The lens L1 may direct the pump beam to be normally incident on the target sample 212. In some implementations, the pump beam may have a non-normal angle of incidence, e.g., between normal and 70° incidence angle.

A vision system 229 may focus on the target sample 212 via the beam splitter 228 and lens L1 and may be used for positioning the target sample 212.

The probe arm 230 may include a motorized half wave plate HWP3 before a variable delay stage 232, which is illustrated as including a number of mirrors, M9, M10, M11, and M12, where the mirror M11 is movable, via a piezoelectric motor, to alter the length of the optical path to control the delay of the pulses in the probe beam produced by probe arm 230 to vary the time delay between pulses in the pump beam and the probe beam.

The probe beam produced by probe arm 230 is directed to the target sample 212 via mirrors M13, M7, M14 and lens L2. The lens L2 may include one or more reflective or refractive lenses or combination thereof. The lens L2 directs the probe beam to be obliquely incident on the target sample 212.

The detector arm 140 receives the reflected beam from the target sample 212 via lens L3 and mirrors M15 and M16. The lens L3 may include one or more reflective or refractive lenses or combination thereof. The detector arm 140 includes a detector 244, which may be a Si-based photodector produced by Thorlabs.

The detector 244 may be connected to a lock-in amplifier 248 that receives the signals from the detector 244 that are generated based on the received reflected probe pulses in the reflected beam from the target sample 212 and demodulates the signals based on the dc frequency component produced by the light source 202, and the modulation frequencies produced by the EOM 226 in the pump arm 220, if used.

As illustrated, the opto-acoustic metrology device 200 may additionally include a stage 214 that includes a chuck for holding the target sample 212 and actuators for moving the target sample 212 to a desired positioning system. The stage 214, for example, may be capable of horizontal motion in either Cartesian (i.e., X and Y) coordinates, or Polar (i.e., R and θ) coordinates or some combination of the two. The stage may also be capable of vertical motion along the Z coordinate.

The detector 244, e.g., or the lock-in amplifier 248, as well as other components of the opto-acoustic metrology device 200, such as the light source 202, pump variable delay stage 222, EOM 226, probe variable delay stage 232, the wavelength selector (multi-wavelength generator 234), stage 214, etc., may be coupled to at least one controller 250, such as a workstation, a personal computer, central processing unit or other adequate computer system, or multiple systems. It should be understood that the controller 250 includes one or more processing units 252 that may be separate or linked processors, and controller 250 may be referred to herein sometimes as a processor 250, at least one processor 250, one or more processors 250, etc. The controller 250 is preferably included in, or is connected to, or otherwise associated with opto-acoustic metrology device 200. The controller 250, for example, may control the positioning of the target sample 212, e.g., by controlling movement of the stage 214 on which the target sample 212 is held. The controller 250 may further control the operation of a chuck on the stage 214 used to hold or release the target sample 212. The controller 250 may also collect and analyze the data obtained from the detector 244. The controller 250 may analyze the data to determine one or more physical characteristics of the sample based on opto-acoustic metrology, etc., as discussed herein. In some implementations, the measured data may be obtained and compared to a modeled data, which may be stored in a library or obtained in real time. Parameters of the model may be varied, and modeled data compared to the measured data, e.g., in a linear regression process, until a good fit is achieved between the modeled data and the measured data, at which time the modeled parameters are determined to be the characteristics of the target sample 212.

The controller 250 includes at least one processing unit 252 and memory 254, as well as a user interface including e.g., a display 256 and input devices 258. A non-transitory computer-usable storage medium 259 having computer-readable program code embodied may be used by the at least one processor 252 for causing the at least one processor 252 to control the opto-acoustic metrology device 200 and to perform the measurement functions and analysis described herein. The data structures and software code for automatically implementing one or more acts described in this detailed description can be implemented by one of ordinary skill in the art in light of the present disclosure and stored, e.g., on a computer-usable storage medium 259, which may be any device or medium that can store code and/or data for use by a computer system such as processing unit 252. The computer-usable storage medium 259 may be, but is not limited to, flash drive, magnetic and optical storage devices such as disk drives, magnetic tape, compact discs, and DVDs (digital versatile discs or digital video discs). A communication port 257 may also be used to receive instructions that may be stored on memory 254 and used to program the processor 250 to perform any one or more of the functions described herein and may represent any type of communication connection, such as to the internet or any other computer network. The communication port 257 may further export signals, e.g., with measurement results and/or instructions, to another system, such as external process tools, in a feed forward or feedback process in order to adjust a process parameter associated with a fabrication process step of the samples based on the measurement results. Additionally, the functions described herein may be embodied in whole or in part within the circuitry of an application specific integrated circuit (ASIC) or a programmable logic device (PLD), and the functions may be embodied in a computer understandable descriptor language which may be used to create an ASIC or PLD that operates as herein described. The results from the analysis of the data may be stored, e.g., in memory 254 associated with the sample and/or provided to a user, e.g., via display 256, an alarm, data set, or other output device. Moreover, the results from the analysis may be fed back to the process equipment to adjust the appropriate patterning step to compensate for any detected variances in the processing.

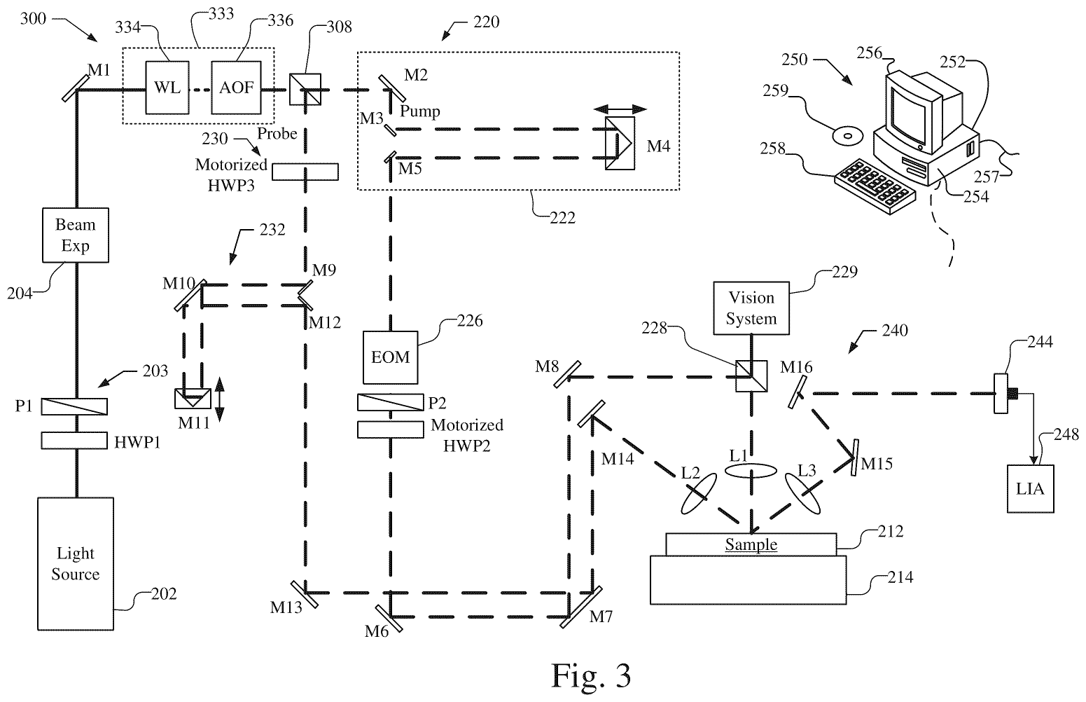

FIG. 3 illustrates a schematic representation of an opto-acoustic metrology device 300, which illustrates an implementation of the opto-acoustic metrology device 100 shown in FIG. 1A, and which is similar to opto-acoustic metrology device 200 shown in FIG. 2, like designated elements may be the same. As illustrated with the dashed lines in FIG. 3, the opto-acoustic metrology device 300 produces pump pulses and probe pulses with the same wavelengths that are incident on the sample 212.

In the opto-acoustic metrology device 300, a wavelength selector 333 is located before the beam splitter 308. The wavelength selector 333 includes a multi-wavelength generator 334 that receives the pulsed light from a pulsed light source 202 and expands the spectrum of the pulsed light. The multi-wavelength generator 334 may be the same as multi-wavelength generator 234, shown in FIG. 2. The wavelength selector 333 additionally includes a filter 336, that may select one or more wavelengths to direct to the beam splitter 308. The filter 336, for example, may be an acousto-optic filter, a dichroic mirror, laser line filter, notch filters, etc. and may be varied to select different wavelengths to direct to the beam splitter 308. The beam splitter 308 may be a non-polarizing beam splitter that separates the pulsed light and directs a portion (e.g., 50%) to the pump arm 220 and directions another portion (e.g., 50%) to the probe arm 230. The wavelength selector 333, with multi-wavelength generator 334 and filter 336 may be used as the wavelength selector 133, shown in FIG. 1A. The beam splitter 308 may be used as the optical system 115, shown in FIG. 1A.

Thus, the pump pulses and the probe pulses incident on the sample 212 have the same wavelength(s) that is (are) selected by the wavelength selector 333.

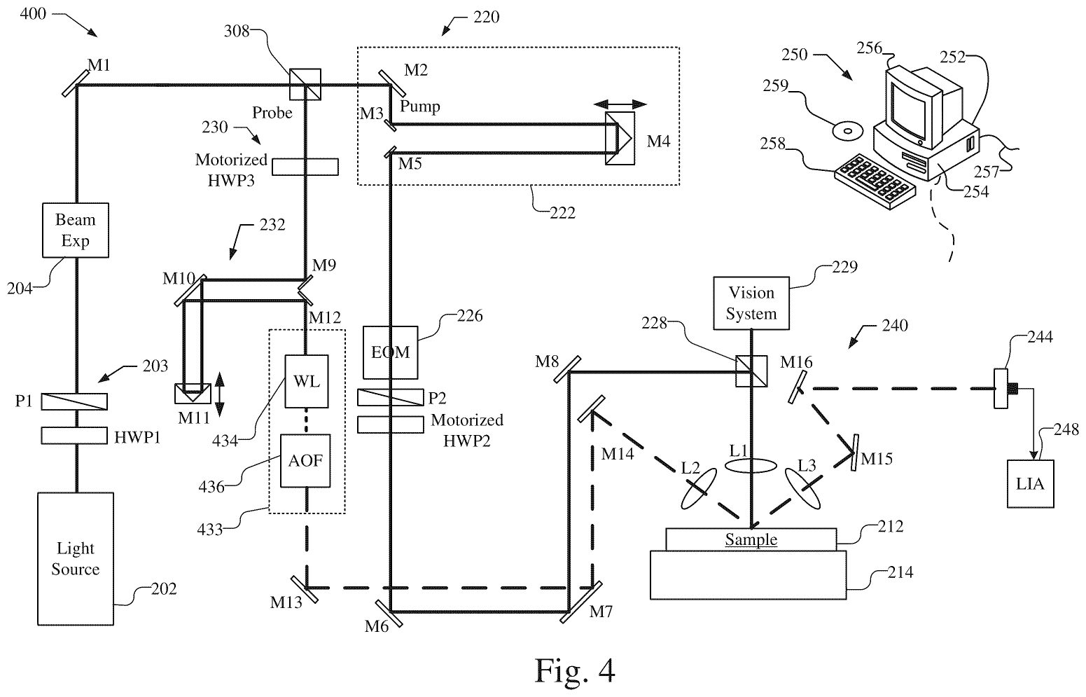

FIG. 4 illustrates a schematic representation of an opto-acoustic metrology device 400, which illustrates an implementation of the opto-acoustic metrology device 100 shown in FIG. 1A, and which is similar to opto-acoustic metrology devices 200, 300 as shown in FIGS. 2 and 3, like designated elements may be the same.

As illustrated in FIG. 4, the wavelength selector 433 is located within the probe arm 230, unlike opto-acoustic metrology device 100 and 200, which show that the wavelength selection occurs before the probe arm 230. Thus, in the opto-acoustic metrology device 400, both the pump arm 220 and the probe arm 230 receive the same wavelengths of pulsed light from the light source 202, via the beam splitter 308. The wavelength selection is performed in only one arm, illustrated as probe arm 230 in FIG. 4 (but in some implementations, may be in the pump arm 220), while the other arm, illustrated as pump arm 220 (but in some implementations, may be the probe arm 230) receives the pulsed light same wavelength(s) as generated by the light source 202. Thus, as illustrated with the dashed lines in FIG. 4, the pump pulses and the probe pulses incident on the sample 212 have different wavelength(s) that is (are) controlled by the light source 202 and the wavelength selector 433 in the probe arm 230.

The wavelength selector 433 in opto-acoustic metrology device 400, may be similar to wavelength selector 333 in opto-acoustic metrology device 300 shown in FIG. 3. The wavelength selector 433, for example, may include a multi-wavelength generator 434 that receives (in the probe arm 230) the pulsed light from the pulsed light source 202 and expands the spectrum of the pulsed light. The multi-wavelength generator 434 may be the same as multi-wavelength generator 234, shown in FIG. 2. The wavelength selector 433 additionally includes a filter 436, that may select one or more wavelengths to be used as the probe pulses. The filter 436 may be the same as the filter 336, shown in FIG. 3. While FIG. 4 illustrates the wavelength selector 433 between the probe delay 232 and the mirror M13, it should be understood that the wavelength selector 433 may be in other locations.

Moreover, the components of the wavelength selector 433, e.g., the multi-wavelength generator 434 and filter 436 may be separated. The wavelength selector 433, with multi-wavelength generator 434 and filter 436 may be used as the wavelength selector 133, shown in FIG. 1A.

Thus, the pump pulses produced by the pump arm 220 have the same wavelengths as generated by the light source 202, while the probe pulses generated by the probe arm 230 have one or more different wavelengths selected by the wavelength selector 433. Selecting the wavelengths to use in the probe pulses may be advantageous, for example, for targets with different pieozoreflectances.

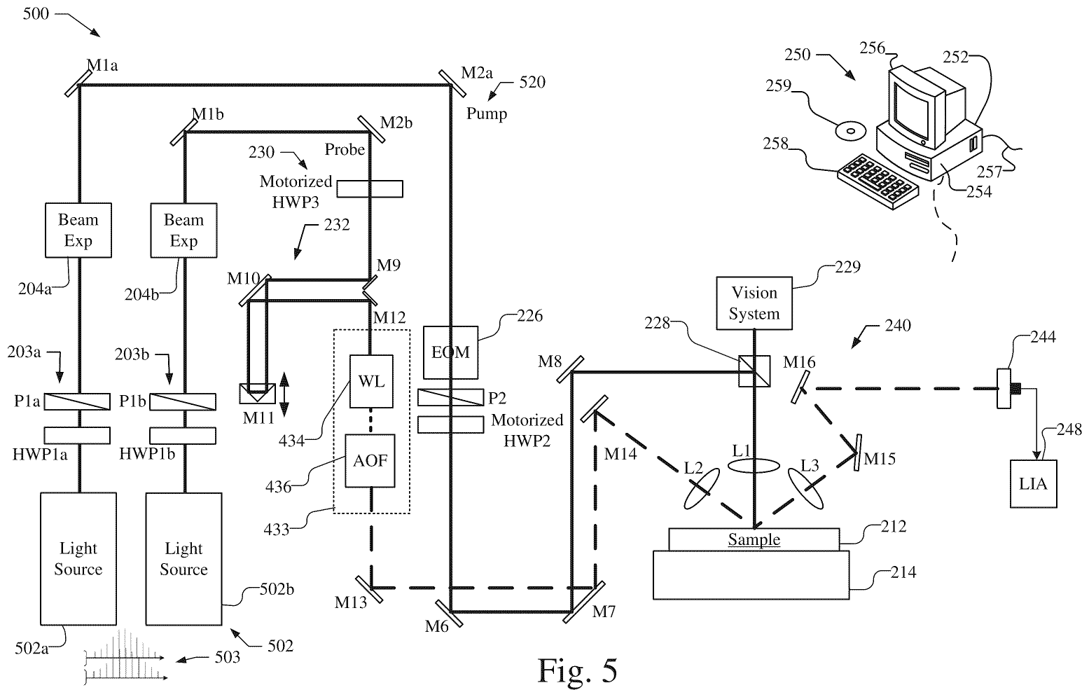

FIG. 5 illustrates a schematic representation of an opto-acoustic metrology device 500, which illustrates an implementation of the opto-acoustic metrology device 100 shown in FIG. 1A, and which is similar to opto-acoustic metrology devices 200, 300, 400 as shown in FIGS. 2-4, like designated elements may be the same.

As illustrated in FIG. 5, the opto-acoustic metrology device 500 includes the wavelength selector 433 located within the probe arm 230, similar to opto-acoustic metrology device 400 shown in FIG. 4. The opto-acoustic metrology device 500, however, illustrates a heterodyne configuration in which the light source 502 generates a separate pump beam and probe beam with synchronized lasers 502a and 502b. As illustrated by graph 503, the laser pulses generated by synchronized lasers 502a and 502b have slightly different frequencies (i.e., repetition rates), which provides a varying delay between the pump pulse and probe pulse. With the use of a heterodyne configuration, the variable delay stage 222 for controlling the delay between the pump pulse and probe pulse, used in homodyne configurations shown in FIGS. 2-4, is unnecessary, and therefore may be omitted from the pump arm 520 as illustrated in FIG. 5. With the use of separate pulsed beams for the pump arm 520 and the probe arm 230, the light may be directed through separate intensity controls 203a and 203b, respectively including half wave plates HWP1a, HWP1b and polarizers P1a, P1b. The light may also pass through separate beam expanders 204a, 204b, respectively, each of which may include a series of lenses that expands the beams. The light source 502, including synchronized lasers 502a, 502b with differing frequencies, intensity controls 203a, 203b, and beam expanders 204a, 204b may be used as the pulsed light source 110 illustrated in FIG. 1A.

Moreover, with the use of separate pulsed beams for the pump arm 520 and the probe arm 230, a beam splitter is unnecessary to direct light from the light source 502 to the pump arm 520 and the probe arm 230. Thus, as illustrated in FIG. 5, the pump light and probe light from the light source 502 may be directed to the pump arm 520 and the probe arm 230 using mirrors M1a, M1b and M2a, M2b, respectively.

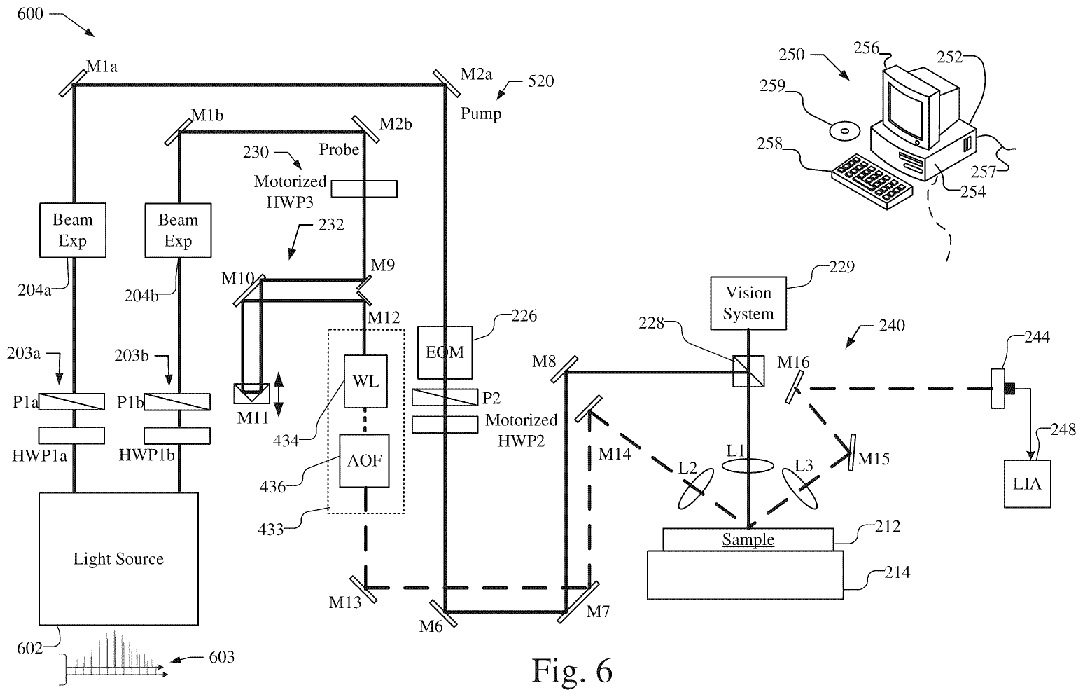

FIG. 6 illustrates a schematic representation of an opto-acoustic metrology device 600, which illustrates an implementation of the opto-acoustic metrology device 100 shown in FIG. 1A, and which is similar to opto-acoustic metrology devices 200, 300, 400, 500 as shown in FIGS. 2-5, like designated elements may be the same.

As illustrated in FIG. 6, the opto-acoustic metrology device 500 includes the wavelength selector 433 located within the probe arm 230, similar to opto-acoustic metrology devices 400 and 500 shown in FIGS. 4 and 5. The opto-acoustic metrology device 600, however, illustrates a heterodyne configuration in which the light source 602 generates a separate pump beam and probe beam that have slightly different frequencies (i.e., repetition rates), as illustrated by graph 603, which provides a varying delay between the pump pulse and probe pulse. As illustrated by graph 503. The light source 602 that produces separate beams with differing frequencies, intensity controls 203a, 203b, and beam expanders 204a, 204b may be used as the pulsed light source 110 illustrated in FIG. 1A.

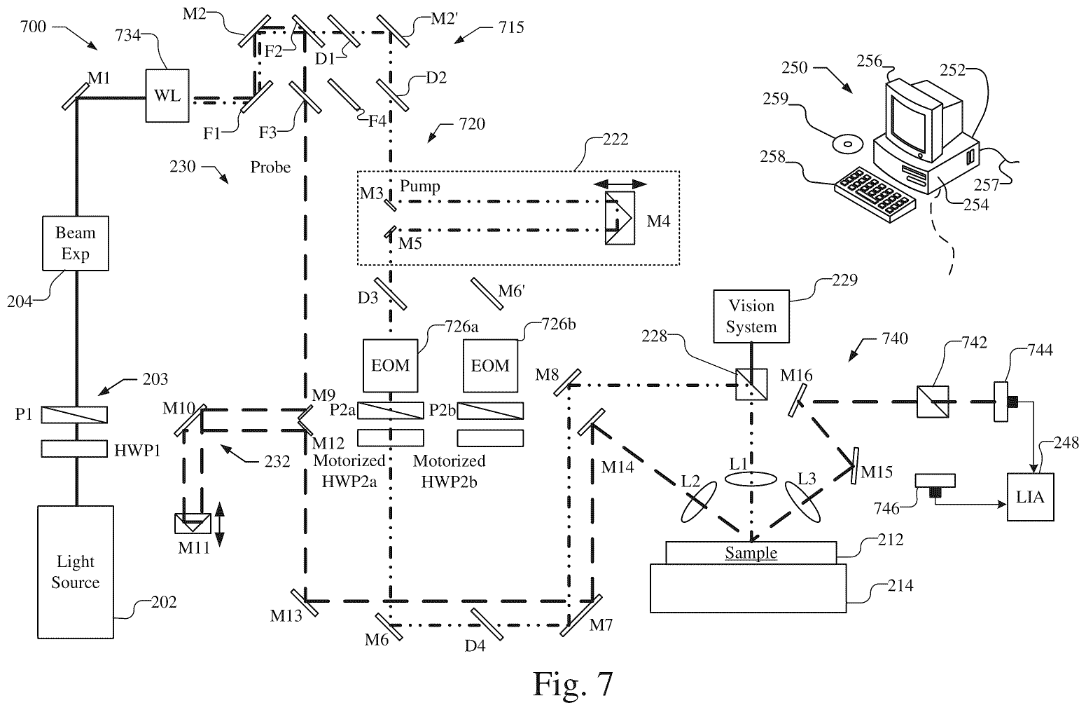

FIGS. 7-10 illustrate a schematic representation of an opto-acoustic metrology device 700, which illustrates an implementation of the opto-acoustic metrology device 100 shown in FIG. 1A, and which is similar to opto-acoustic metrology device 200 shown in FIG. 2, like designated elements may be the same. Similar to the opto-acoustic metrology device 200 shown in FIG. 2, the opto-acoustic metrology device 700 may include a wavelength selector is in the form of a multi-wavelength generator 734 that is between the pulsed light source 202 and optical elements used to direct the pulsed light to a pump arm 720 and a probe arm 230.

The multi-wavelength generator 734 receives the pulsed light from a pulsed light source 202 and expands the pulsed light into a dis-continuous spectrum. The multi-wavelength generator 734, for example, may be a photonic crystal fibers with two 0 dispersion regions, with different wavelengths. The 0 dispersion regions, for example, may have wavelengths 21 and 22 that are close to each other, e.g., 775 nm and 945 nm. The multi-wavelength generator 734 may produce spectral bands around the 0 dispersion region wavelengths.

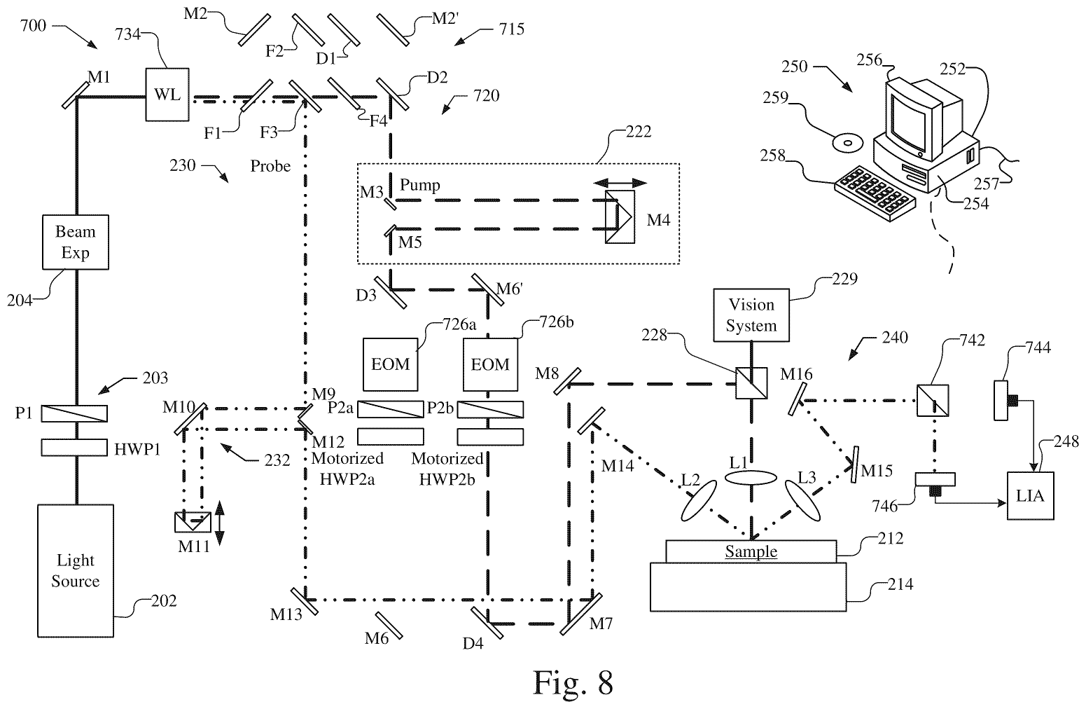

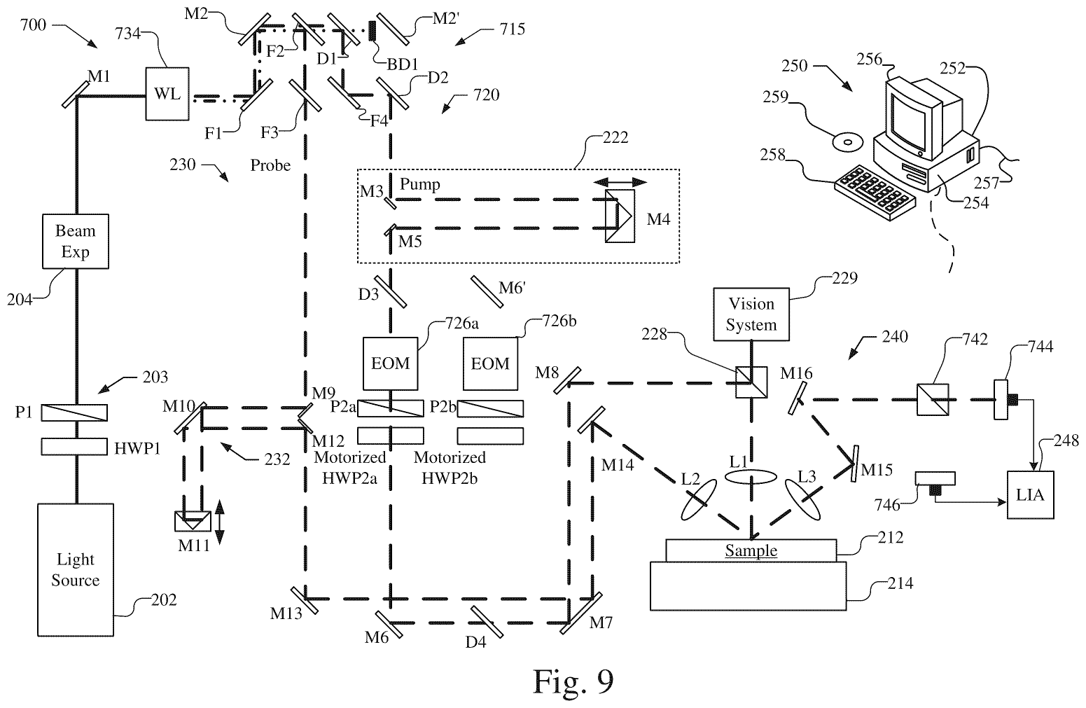

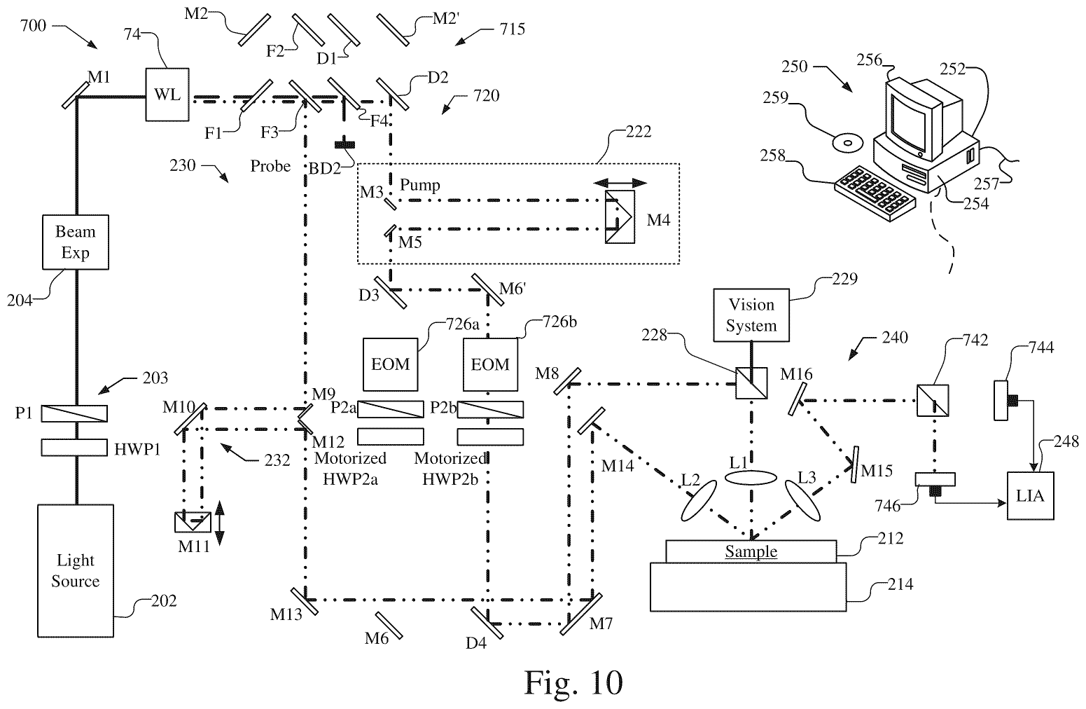

The opto-acoustic metrology device 700 includes optical elements 715 that may be configured to direct different wavelengths of pulsed light to the pump arm 720 and the probe arm 230, e.g., as illustrated with dashed lines in FIGS. 7 and 8, or to direct the same selected wavelengths of pulsed light to the pump arm 720 and the probe arm 230, e.g., as illustrated with dashed lines in FIGS. 9 and 10. For example, as illustrated in FIG. 7, the optical elements 715 may be used to direct a first wavelength (illustrated with dashed and dotted lines) of pulsed light to the pump arm 720 and a second wavelength (illustrated with dashed lines) of pulsed light to the probe arm 230, and as illustrated in FIG. 8, the optical elements 715 may be used to direct the second wavelength (illustrated with dashed lines) of pulsed light to the pump arm 720 and the first wavelength (illustrated with dashed and dotted lines) of pulsed light to the probe arm 230. Further, as illustrated in FIG. 9, the optical elements 715 may be used to direct the second wavelength (illustrated with dashed lines) of pulsed light to both the pump arm 720 and the probe arm 230, and as illustrated in FIG. 8, the optical elements 715 may be used to direct the first wavelength (illustrated with dashed and dotted lines) of pulsed light both the pump arm 720 and the probe arm 230. Thus, the multi-wavelength generator 734 and optical elements 715 may be used as the wavelength selector 133′, including the multi-wavelength generator 134 and filter 136, as well as the optical system 115, shown in FIG. 1A.

The optical elements 715, by way of example, may include a number of filters, such as filter wheels, F1, F2, F3, F4, one or more dichroic elements, such as dichroic mirrors D1, D2, mirrors M2, M2′, and movable beam dumps BD1, BD2. The filter wheels may be adjusted to transmit or reflect desired wavelengths of light to direct the desired different or same wavelengths of pulsed light to the pump arm 720 and the probe arm 230, e.g., as illustrated with dashed lines and dashed and dotted lines in FIGS. 7-10.

The pump arm 720 may be similar to the pump arm 220 shown in FIG. 2, but because different wavelengths of light may be selected to be directed to the pump arm 720, the pump arm 720 may include additional wavelength sensitive components. For example, the pump arm 720 may include two sets of EOMs 726a, 726b which may be sensitive for the different wavelengths that may be selected to be used by the pump arm 720. Along with EOMs 726a, 726b, corresponding polarizers P2a, P2b, and motorized half waveplate HWP2a, HWP2b may be used, as well as an additional dichroic mirrors D3, D4, and mirror M6, M6b.

Additionally, the detector arm 740 may be configured to split the reflected beam, e.g., using a beam splitter 742 and use separate two separate detectors, e.g., detector 744 and 746, which may be a Si-based photodetectors, to detect the reflected beam from the target sample 212. Both detectors 746, 744 may be connected to the lock-in amplifier 248. The two detectors 744 and 746 may be used for, e.g., surface deflection measurements based on a difference measurement of the signal detected by detectors 744 and 746. It should be understood that detector arm 740 may be used in any of the configurations described in FIGS. 3-6.

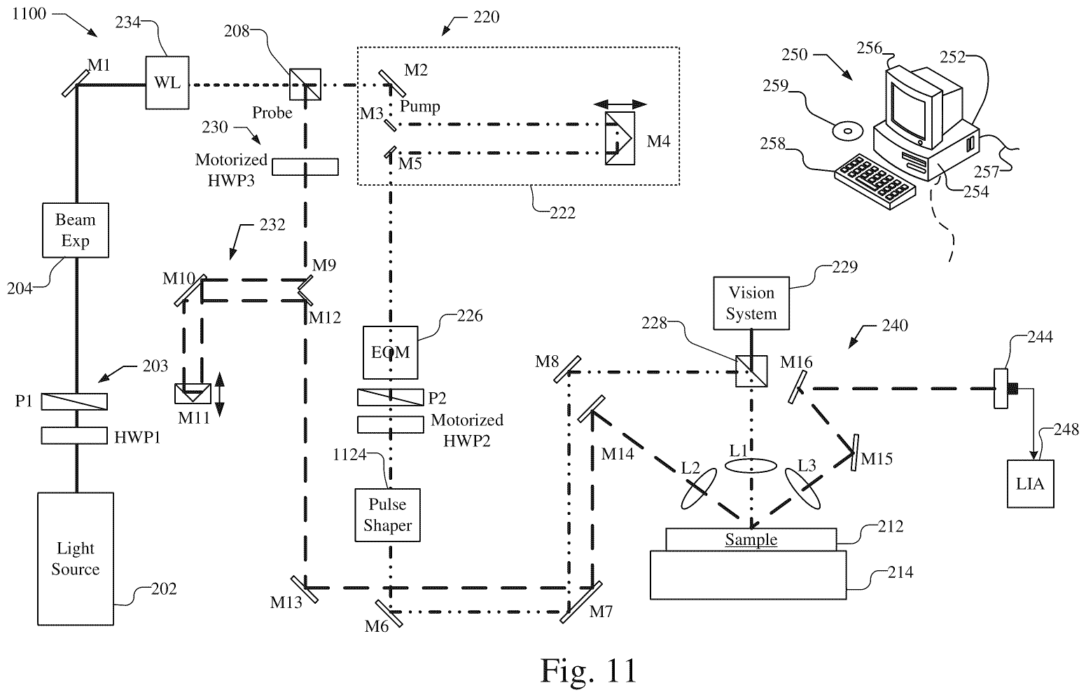

FIG. 11 illustrates a schematic representation of an opto-acoustic metrology device 1100, which illustrates an implementation of the opto-acoustic metrology device 100 shown in FIG. 1A, and which is similar to opto-acoustic metrology device 200 shown in FIG. 2, like designated elements may be the same.

As illustrated, the opto-acoustic metrology device 1100 may include a pulse shaper 1124 within the pump arm 220. The pulse shaper 1124 receives the pulsed light beam in the pump arm 220 and varies at least one of a duration, phase, or both of the pulses in the pulsed light beam in the pump beam. The pulse shaper 1124, for example, may be a spatial light modulator or an acousto-optic modulator. For example, a spatial light modulator, such as a liquid crystal SLM, manufactured by Jenoptik, may be used, or an acousto-optic modulator, such as KD*P crystal based EOM, manufactured by Conoptics, may be used. The pulse shaper 1124 may be used to vary the pulse duration and/or phase of the incident pump beam to determine the dependence of the magnetic dynamics in the target sample 212 on the pump pulse characteristics. Moreover, an adaptive algorithm may be used to define and use the optimum pulse shape of the pump beam to yield desirable control over the magnetic dynamics in the target sample 212 under consideration, e.g., by altering the pulse shape in the pump beam until a strongest response is detected. The pulse shaper 1124 may be used as the pulse shaper 124, shown in FIG. 1A. While pulse shaper 1124 is illustrated in an opto-acoustic metrology device 200 like configuration, it should be understood that pulse shaper 1124 may be used in any of the opto-acoustic metrology devices disclosed herein.

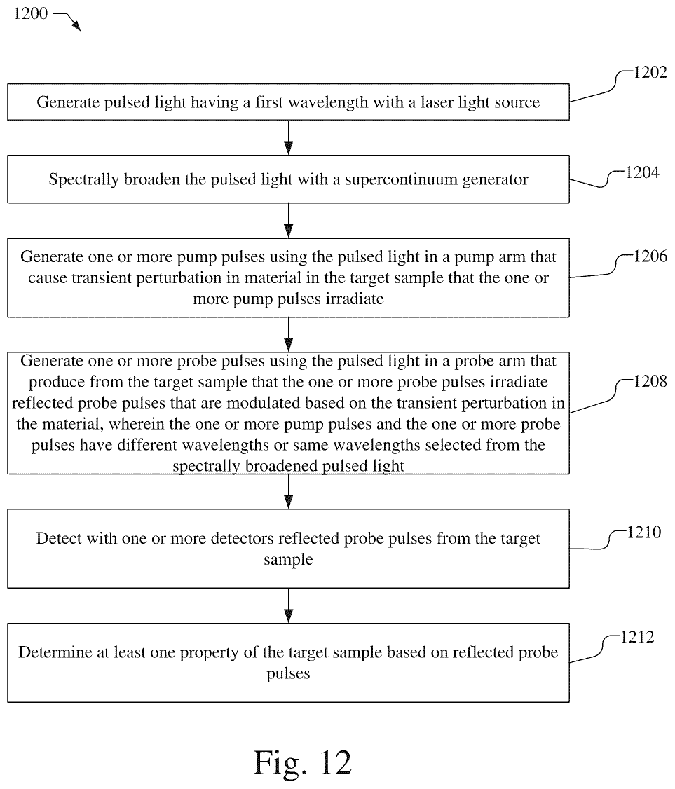

FIG. 12 is a flow chart 1200 illustrating a method for non-destructive opto-acoustic metrology of a target sample using an opto-acoustic metrology device, such as opto-acoustic metrology devices illustrated in FIGS. 1A, 2-11 and discussed herein.

At block 1202, the opto-acoustic metrology device generates pulsed light having a first wavelength with a laser light source, e.g., as illustrated by pulsed light source 110, light sources 202, 502, or 602, as illustrated herein. The opto-acoustic metrology device, for example, may include a light source for a homodyne configuration, e.g., with a single laser that generates the pulsed light that is split between the pump and probe arms with a variable delay stage used to generate the delay between the pump and probe pulses, or a heterodyne configuration, in which the light source generates separate pump and probe beams (with two synchronized lasers or a single laser) with the delay between the pump and probe produced based on slightly different frequencies of the pulses in the pump and probe beams.

At block 1204, the opto-acoustic metrology device spectrally broadens the pulsed light with a supercontinuum generator, e.g., as illustrated in FIGS. 1A, and 2-11 herein. The supercontinuum generator, for example, may include multi-wavelength generator, such as a multiple harmonic generator (e.g., DBO), which in some implementations may be photonic crystal fibers that receive a narrow band of wavelengths and produce wider band of wavelengths, and may broaden the spectrum to a continuous optical spectrum or a dis-continuous optical spectrum. A means for spectrally broadening the pulsed light may include, e.g., any of multi-wavelength generators 134, 234, 334, 434, or 734, as illustrated in FIGS. 1A, and 2-11 herein.

At block 1206, the opto-acoustic metrology device generates one or more pump pulses using the pulsed light in a pump arm that cause transient perturbation in material in the target sample that the one or more pump pulses irradiate, e.g., as illustrated by pump arms 120, 220, 520, and 720 discussed in reference to FIGS. 1A, and 2-11. The pump arm, for example, may include a variable delay stage used to generate the delay between the pump and probe pulses in some implementations (e.g., for a homodyne configuration) or may not include a variable delay stage to generate the delay between the pump and probe pulses (e.g., for a heterodyne configuration).

At block 1208, the opto-acoustic metrology device generates one or more probe pulses using the pulsed light in a probe arm that produce from the target sample that the one or more probe pulses irradiate reflected probe pulses that are modulated based on the transient perturbation in the material, wherein the one or more pump pulses and the one or more probe pulses have different wavelengths or same wavelengths selected from the spectrally broadened pulsed light, e.g., as illustrated by probe arms 130, 230 discussed in reference to FIGS. 1A, and 2-11. The one or more pump pulses and the one or more probe pulses have different wavelengths or same wavelengths selected from the spectrally broadened pulsed light, e.g., due to a wavelength selector, which may be a filter, for example, may be an AOF, a dichroic mirror or beam splitter, laser line filter, notch filters, etc. For example, a means for selecting from the spectrally broadened pulsed light different wavelengths for the one or more pump pulses and the one or more probe pulses may be the filter 136, optical system 115, dichroic beam splitter 208, filter 336, or filter 436 discussed in reference to FIGS. 1A, and 2-11. The wavelength selection of different wavelengths from the spectrally broadened pulsed light for the one or more pump pulses and the one or more probe pulses may occur in the optical path prior to the pump arm and probe arm, or may occur within the either the pump arm or the probe arm, e.g., as illustrated in FIGS. 4-6.

At block 1210, the opto-acoustic metrology device detects with one or more detectors reflected probe pulses from the target sample, e.g., as illustrated by detector arm 140 using detectors 144 and/or 146, detector arm 240 using detector 244, or detector arm 740 using detectors 744 and 746, discussed in reference to FIGS. 1A, and 2-11.

At block 1212, the opto-acoustic metrology device determines at least one property of the target sample based on reflected probe pulses, e.g., as discussed in reference to controller 150 illustrated in FIG. 1A or controller 250 illustrated in FIGS. 2-11.

In some implementations, the pulsed light may be spectrally broadened to include a second wavelength and a third wavelength by the supercontinuum generator before the pump arm and the probe arm, and the opto-acoustic metrology device may further direct the second wavelength to the pump arm and direct the third wavelength to the probe arm, e.g., as discussed in reference to FIGS. 1A, 2, 3, and 7-11. Thus, the one or more pump pulses and one or more probe pulses may have different wavelengths. A means for directing the second wavelength to the pump arm and directing the third wavelength to the probe arm, for example, may be, e.g., the optical system 115, the dichroic beam splitter 208, or the optical elements 715, which may include one or more filters, e.g., filter wheels, one or more dichroic elements, such as dichroic mirrors or beam splitters, one or more mirrors, etc., as discussed in reference to FIGS. 1A, 2, 3, and 7-11.

In some implementations, the pulsed light may be spectrally broadened by the supercontinuum generator within one of the pump arm and the probe arm, e.g., as illustrated in FIGS. 4-6. Additionally, in some implementations, the opto-acoustic metrology device may further select a second wavelength with a wavelength selecting filter from the pulsed light that is spectrally broadened by the supercontinuum generator, e.g., as illustrated in FIGS. 4-6. Thus, the one or more pump pulses and one or more probe pulses may have different wavelengths. A means for selecting a second wavelength with a wavelength selecting filter from the pulsed light that is spectrally broadened by the supercontinuum generator may be, e.g., a filter, such as filter 136, or 436 discussed in reference to FIG. 1A, or 4-6. The filter, for example, may be an AOF, a dichroic mirror or beam splitter, laser line filter, notch filters, etc.

In some implementations, the pulsed light is spectrally broadened before the pump arm and the probe arm, e.g., as discussed in reference to FIGS. 1A, 2, 3, and 7-11. The opto-acoustic metrology device may further select a second wavelength with a wavelength selecting filter from the pulsed light and direct the pulsed light with the second wavelength to the pump arm and the probe arm, e.g., as discussed in reference to FIGS. 1A, 3, and 7-11. Thus, the one or more pump pulses and one or more probe pulses may have the same wavelengths, which are different than the first wavelength of the pulsed light produced by the laser light source. A means for selecting a second wavelength from the pulsed light may be, e.g., a wavelength selecting filter such as wavelength selector 133, optical system 115, filter 336, or optical elements 715 discussed in reference to FIG. 1A or 4-6. The wavelength selector, for example, may include one or more of an AOF, a dichroic mirror or beam splitter, laser line filter, notch filters, beam dumps, etc., e.g., as discussed in reference to FIGS. 1A, 3, and 7-11. A means for directing the pulsed light with the second wavelength to the pump arm and the probe arm may be, e.g., optical system 115, beam splitter 308, or optical elements 715 discussed in reference to FIG. 1A or 4-6.

In some implementations, the opto-acoustic metrology device may further shape at least the portion of the pulsed light to vary at least one of a duration, phase, or both of the one or more pump pulses, e.g., using a pulse shaper 1124 as discussed in FIG. 11. A means for shaping at least a portion of the pulsed light beam to vary at least one of a duration, phase, or both of the one or more pump pulses, for example, may include a spatial light modulator or an acousto-optic modulator.

Although the present invention is illustrated in connection with specific embodiments for instructional purposes, the present invention is not limited thereto. Various adaptations and modifications may be made without departing from the scope of the invention. Therefore, the spirit and scope of the appended claims should not be limited to the foregoing description.

What is claimed is:

1. An opto-acoustic metrology device for non-destructive metrology of a target sample, comprising:
a laser light source for generating pulsed light having a first wavelength;
a supercontinuum generator that receives the pulsed light having the first wavelength and spectrally broadens the pulsed light;
a pump arm that is configured to receive the pulsed light and to irradiate the target sample with one or more pump pulses to cause transient perturbation in material in the target sample;
a probe arm that is configured to receive the pulsed light and to irradiate the target sample with one or more probe pulses to produce reflected probe pulses that are modulated based on the transient perturbation in the material, wherein the one or more pump pulses and the one or more probe pulses have different wavelengths or same wavelengths selected from the spectrally broadened pulsed light;
one or more detectors for receiving reflected probe pulses from the target sample; and
at least one processor coupled to the one or more detectors and configured to determine at least one property of the target sample based on reflected probe pulses.

2. The opto-acoustic metrology device of claim 1, wherein the laser light source generates a single pulsed light beam or two pulsed light beams with different frequency combs.

3. The opto-acoustic metrology device of claim 1, wherein the supercontinuum generator comprises photonic crystal fibers.

4. The opto-acoustic metrology device of claim 1, wherein the supercontinuum generator is located before the pump arm and the probe arm and spectrally broadens the pulsed light to include a second wavelength and a third wavelength, further comprising a dichroic beam splitter that directs the pulsed light with the second wavelength to the pump arm and directs the pulsed light with the third wavelength to the probe arm.

5. The opto-acoustic metrology device of claim 1, wherein the supercontinuum generator is located within one of the pump arm and the probe arm.

6. The opto-acoustic metrology device of claim 5, further comprising a wavelength selecting filter that receives the pulsed light that is spectrally broadened by the supercontinuum generator and selects a second wavelength.

7. The opto-acoustic metrology device of claim 1, wherein the supercontinuum generator is located before the pump arm and the probe arm and spectrally broadens the pulsed light to include a second wavelength and a third wavelength, further comprising:
a wavelength selecting filter that receives the pulsed light that is spectrally broadened by the supercontinuum generator and selects the second wavelength; and
one or more optical elements that direct the pulsed light with the second wavelength to the pump arm and to the probe arm.

8. The opto-acoustic metrology device of claim 1, further comprising a pulse shaper that shapes at least a portion of the pulsed light to vary at least one of a duration, phase, or both of the one or more pump pulses.

9. The opto-acoustic metrology device of claim 8, wherein the pulse shaper comprises one of a spatial light modulator or an acousto-optic modulator.

10. A method for non-destructive opto-acoustic metrology of a target sample using an opto-acoustic metrology device, comprising:
generating pulsed light having a first wavelength with a laser light source;
spectrally broadening the pulsed light with a supercontinuum generator;
generating one or more pump pulses using the pulsed light in a pump arm that cause transient perturbation in material in the target sample that the one or more pump pulses irradiate;
generating one or more probe pulses using the pulsed light in a probe arm that produce from the target sample that the one or more probe pulses irradiate reflected probe pulses that are modulated based on the transient perturbation in the material, wherein the one or more pump pulses and the one or more probe pulses have different wavelengths or same wavelengths selected from the spectrally broadened pulsed light;
detecting with one or more detectors reflected probe pulses from the target sample; and
determining at least one property of the target sample based on reflected probe pulses.

11. The method of claim 10, wherein the pulsed light is spectrally broadened to include a second wavelength and a third wavelength by the supercontinuum generator before the pump arm and the probe arm, further comprising directing the second wavelength to the pump arm and directing the third wavelength to the probe arm.

12. The method of claim 10, wherein the pulsed light is spectrally broadened by the supercontinuum generator within one of the pump arm and the probe arm.

13. The method of claim 12, further comprising selecting a second wavelength with a wavelength selecting filter from the pulsed light that is spectrally broadened by the supercontinuum generator.

14. The method of claim 10, wherein the pulsed light is spectrally broadened before the pump arm and the probe arm, further comprising:
selecting a second wavelength with a wavelength selecting filter from the pulsed light; and
directing the pulsed light with the second wavelength to the pump arm and the probe arm.

15. The method of claim 10, further comprising shaping at least a portion of the pulsed light to vary at least one of a duration, phase, or both of the one or more pump pulses.

16. An opto-acoustic metrology device for non-destructive metrology of a target sample, comprising:
a laser light source for generating pulsed light having a first wavelength;
means for spectrally broadening the pulsed light;
a pump arm that is configured to receive the pulsed light and to irradiate the target sample with one or more pump pulses to cause transient perturbation in material in the target sample;
a probe arm that is configured to receive the pulsed light and to irradiate the target sample with one or more probe pulses to produce reflected probe pulses that are modulated based on the transient perturbation in the material, wherein the one or more pump pulses and the one or more probe pulses have different wavelengths or same wavelengths selected from the spectrally broadened pulsed light
one or more detectors for receiving reflected probe pulses from the target sample; and
at least one processor coupled to the one or more detectors and configured to determine at least one property of the target sample based on reflected probe pulses.

17. The opto-acoustic metrology device of claim 16, wherein the pulsed light is spectrally broadened to include a second wavelength and a third wavelength before the pump arm and the probe arm, further comprising means for directing the second wavelength to the pump arm and directing the third wavelength to the probe arm.

18. The opto-acoustic metrology device of claim 16, wherein the pulsed light is spectrally broadened within one of the pump arm and the probe arm.

19. The opto-acoustic metrology device of claim 16, wherein the pulsed light is spectrally broadened before the pump arm and the probe arm, further comprising:
means for selecting a second wavelength with a wavelength selecting filter from the pulsed light; and
means for directing the pulsed light with the second wavelength to the pump arm and the probe arm.

20. The opto-acoustic metrology device of claim 16, further comprising means for shaping at least a portion of the pulsed light to vary at least one of a duration, phase, or both of the one or more pump pulses.
